(19) United States
(12) Patent Application Publication
(10) Pub. No.: US 2012/0061973 A1
(43) Pub. Date: Mar. 15, 2012

(54) Method and Apparatus for Compressed Gas Energy Storage in Offshore Wind Farms

(76) Inventor: James C. Zelony, Morgan Hill, CA (US)

(21) Appl. No.: 13/230,202

(22) Filed: Sep. 12, 2011

Related U.S. Application Data
(60) Provisional application No. 61/382,031, filed on Sep. 13, 2010.

(51) Int. Cl. F03B 13/10; F02B 3/00; E02D 29/00

(52) U.S. Cl. 290/1 R; 405/210; 137/565.18

(57) ABSTRACT

A method and apparatus for compressed gas energy storage using underwater tanks for storing and releasing compressed gas in offshore wind farms has been disclosed.

### RELATED APPLICATION

This patent application claims priority of U.S. Provisional Application Ser. No. 61/382,031 filed Sep. 13, 2011 titled “Compressed Air Energy Storage for Offshore Wind Farms”, which is hereby incorporated herein by reference.

### FIELD OF THE INVENTION

The present invention relates generally to renewable energy power generators, and more specifically to an energy storage system for storing energy in the form of compressed gas.

### BACKGROUND OF THE INVENTION

Compressed air energy storage (CAES) systems use different storage techniques. For example, some systems use large underground caverns to store compressed air. Large underground cavern systems suffer from thermal dynamic inefficiencies because the compression of ambient temperature air releases heat energy as a waste product. This heat energy is lost to the surrounding environment. When the compressed air is released, it cools and needs to be heated again before entering conventional fossil fuel turbines. It is also difficult to maintain the compressed air at a constant pressure and volume since it continues to cool and lose pressure as it is released. These types of power plants do not exceed much over 50% for an efficiency rating. There are only two such power plants in existence today because they depend on naturally occurring caverns or abandoned mines for storage and the great pressures required make them very costly.

Other current systems use stored compressed air to increase efficiency of burning fossil fuels in power turbines. Some systems use under water remote semi-rigid tanks for storing compressed air or some type of gas. This gas is compressed by an on shore fossil fueled power generator. These systems may suffer from inefficiencies due to pressure loss and also may be susceptible to failure due to natural disasters such as earthquakes.

Thus, there is a need for improved systems for storing and retrieving energy.

### BRIEF DESCRIPTION OF THE DRAWINGS

The invention is illustrated by way of example and not limitation in the figures of the accompanying drawings in which:

FIG. 1 illustrates a system according to various embodiments of the invention.

### DETAILED DESCRIPTION

Embodiments of the present invention improve systems for storing and retrieving energy. In one embodiment, the invention includes a system to store energy of an offshore wind farm. The system comprises a source, a vessel, and a piping system. The source generates compressed gas above a surface of a sea (“sea” hereinafter refers to a water source such as a lake, sea, reservoir, ocean, etc.). The source couples to a generation support tower of the offshore wind farm. The vessel locally stores the compressed gas and has an axis substantially parallel to sea level below the surface of the sea (e.g. in one embodiment of the invention an elongated oval shaped vessel is mounted parallel to the sea level at some depth below the sea level). The piping system couples to the source and the vessel to selectively transfer the compressed gas from the source to the vessel for storage. The vessel is rigid (or may be semi-rigid) and includes at least one port allowing hydrostatic pressure from the sea water to act directly on the compressed gas inside the vessel. The compressed gas may be selectively discharged from the vessel at a substantially constant discharge pressure as the volume of the compressed gas in the vessel decreases. In this embodiment, the gas may have a constant pressure as the decreasing volume of gas is replaced by water.

In one embodiment, an improved lower pressure CAES may be adaptable to offshore wind farms to increase their output during peak energy usage. Such storage systems may also help protect the grid from large spikes of power being generated during storms. The system may be taken off line from the grid and the energy could be directed to the storage systems until the winds stabilize. In another embodiment, the system may be retrofitted into existing offshore wind farms in as little as 10 meters of water. In yet another embodiment, the system may also be adapted to deep water wind farms. In one embodiment, almost all major components may be located above the water for cost effective maintenance and access.

In one embodiment of the invention, the vessel or storage tank may be oval in shape. In one embodiment of the invention, the pressure inside the vessel may be in the range of 90-160 PSIG and may be used to drive a turbine. In one embodiment of the invention, the pressure inside the vessel is determined by the depth at which the vessel is located.

In another embodiment, offshore wind farms (OWF) may utilize off peak electrical capacity to compress gas into storage tanks. The compressed gas may later be used to drive gas-motor or turbine generators during high peak demand. This may also utilize low cost power from the grid for storage and regeneration later at higher demand times if the wind does not produce any power during a 24 hour cycle. This may be a flexible, load shifting solution for a variable renewable resource. This may greatly help reduce green house gases since it does not rely on the burning of any fossil fuels nor does it rely on large underground caverns.

In one embodiment, the system may be used to store the energy of offshore wind farms during low peak production and retrieve the energy during high peak production, wherein the regeneration process does not depend on piping the compressed gas through fossil fueled turbine generating systems. The conversion of the stored energy in the form of compressed gas to utility grade electricity has a very low to zero carbon foot print. This may greatly increase the efficiency of installed offshore wind farms by allowing their power generation to be applied during peak load times and this may be very cost effective compared to installing more offshore wind mills or building more CAES plants.

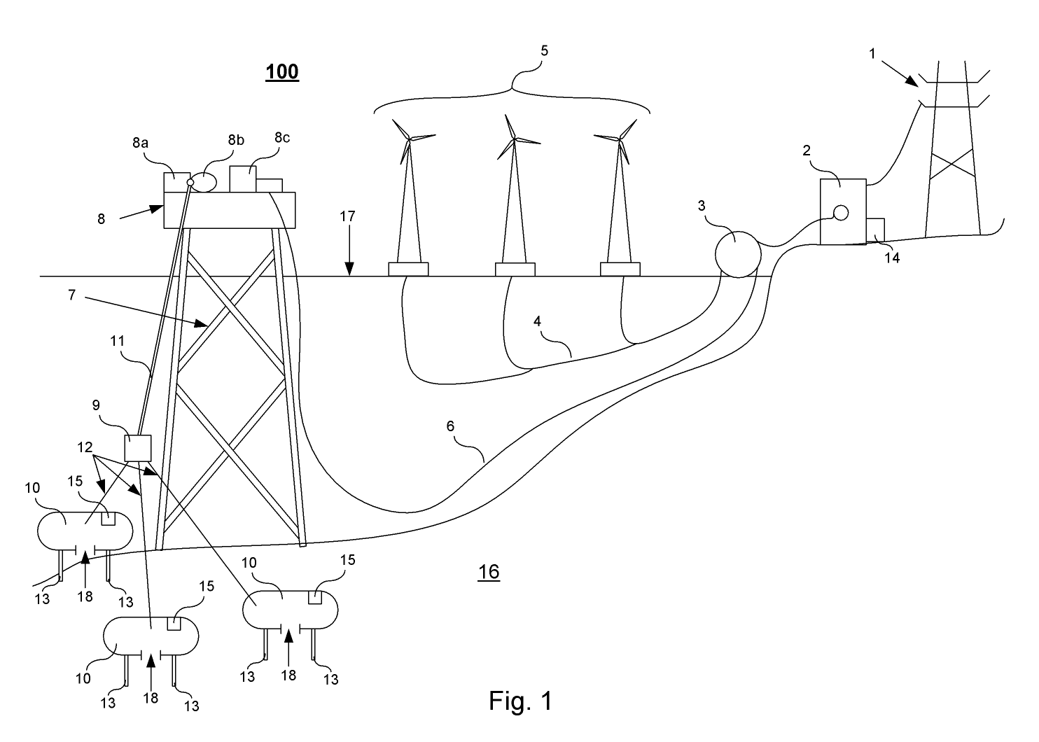

FIG. 1 depicts a system, generally at 100, according to various embodiments of the invention which may include a land based transfer station 2 having a connection to a power transmission tower 1. The land based transfer station 2 being connected to an offshore sub-station 3. The off shore wind farm 5 is connected to the offshore sub-station 3, through standard electrical cabling 4. The sub-station 3 is also connected by electric cable 6 to the power storage and generation support tower 7. The power cable 6 would transport electrical energy to and from the platform 8 and the offshore sub-station 3. The platform 8 also includes a compression side 8a that includes a conventional motor-driven compression train and associated equipment (not shown) for compressing a gas, such as ambient air. The platform machinery also has an expansion side 8b in which the compressed gas is expanded through a conventional pressure expansion train that includes high pressure and low pressure turbines or piston driven gas motors that drive an electrical power generator to generate power. The turbines, gas or air motors, compression and expansion trains, and the power generator may be conventional units.

The transfer station 2 may be located on the ground surface in the vicinity of a coastline near an adjacent sea. having a sea floor 16 that drops off in height as it extends from the coastline and is adjacent to an offshore wind farm. An electrical cable 6 may be connected between the offshore sub-station and the offshore power storage generation platform. It is understood that the piping 11 includes at least one pipe that connects an outlet on the compression side 8a and expansion side 8b of the platform 8 to an inlet on the manifold 9, and at least one pipe that connects an outlet on the manifold 9 to an inlet on each of the vessels 10. The piping system may include branch pipes, valves, etc. (not shown) to enable these connections to be made. The piping system (e.g. piping 11 and conduit 12) and the manifold 9 may be commercially available devices commonly used in offshore piping systems for oil or gas applications.

Vessels 10 may be mounted to the sea floor 16 in the vicinity of the manifold 9. The vessels 10 may be fabricated from a solid material, such as a plastic, metal, or similar material. For example, the vessels 10 may be rigid and define a fixed maximum closed volume. The vessels 10 may have open ports 18 on the bottom to allow water to flow in and out of the vessel. Although not shown in the drawings, it is understood that a suitable inlet and outlet are provided on the manifold 9 and the vessels 10 which can be controlled by valves.

A conduit 12 connects the outlet of the manifold 9 to the inlet of the vessel as well as the outlet of the vessel to the inlet of the manifold so that the gas flow between the manifold and the vessel may be controlled. To this end it is understood that the conduit 12 may be provided with branch end portions and valving (not shown) to make the above connections. Although the vessels 10 are shown substantially cylindrical in shape with rounded ends, it is understood that this shape may vary.

A mooring system 13 may be provided that supports and anchors the vessels 10 slightly above the sea floor 16 with the axis of the vessels 10 extending substantially horizontally. The mooring system 13 may, for example, be in the form of a piling system, an anchor system, a dead weight system, a combination of same, or the like.

When the storage vessels 10 are filled with the pressurized gas, and it is desired to release the gas from the vessel, the above-mentioned outlet valve associated with the vessels 10 are opened and the hydrostatic pressure acting on the vessels 10 cause water to enter the vessels 10 from open ports 18 on the bottom of the storage vessels 10, to force the stored gas out through conduit 12 from the vessel and into the manifold 9 and into the transport pipe of pipes 11. The volume of the vessels 10 and the depth of the vessels 10 below the sea level 17 are determined so that this hydrostatic pressure acting on the vessel enables the gas to be discharged from the vessel at a substantially constant discharge pressure as the volume of the gas in the storage vessel decreases. In particular, the volume of the vessels 10 are determined by the combination of the depth of the vessels 10, the amount of electrical power to be generated by the platform 8, and the run time of the power generation cycle; while the depth of the vessels 10 are determined by the required operating pressure of the air or gas motors or turbines and the volume of the vessels 10. The discharged gas passes through the conduit 12 and into the manifold 9 for return to the platform 8 via the piping 11.

Although only three storage vessels 10 are shown in FIG. 1, it is understood that a plurality of vessels may be provided, in which case the manifold 9 may be connected to each vessel.

A monitoring and control unit 14 may be located on the ground surface and is adapted to monitor the conditions of the platform 8, the piping 11, the conduit 12, the manifold 9, and/or the storage vessels 10, and control the operation of same. In particular, the unit 14 may electrically coupled to numerous sensors which are associated with the platform 8, the piping 11, the conduit 12, the manifold 9, and the vessels 10, respectively. The sensors (e.g. sensor 15 and sensor 8c) sense to monitor the volume, pressure and other parameters of the gas in the system, the piping 11, the conduit 12, the manifold 9, and/or the vessels 10 and send corresponding output signals to the unit 14 in order to perform the monitoring. Also, it is understood that the above-mentioned valves can be operated in any conventional manner, and that the control unit 14 controls the operation of the valves to selectively control the flow of the gas through the piping 11 from the compression side of the platform 8a to the manifold 9, from the manifold 9 to the vessels 10, from the vessels 10 back to the manifold 9, and from the manifold 9 to the expansion side of the platform 8b.

The unit 14 receives the signals from the sensors and may include a microprocessor, or other computing device, to control the flow of the gas through the piping 11 and conduit 12 in the above manner. The unit 14 also can be adapted to monitor other parameters, such as the volume of gas stored in the vessels 10, the electrical power used to compress the gas in the plant, etc. The monitoring and control system may be conventional.

In operation, the compression side 8a of the unit 8 receives a gas, such as air, and compresses it in the manner discussed above, before the gas flows to the manifold 9 via the piping 11, under the control of the control unit 14. The manifold 9 directs the compressed gas into the storage vessels 10 at a flow rate that produces a pressure greater than the hydrostatic pressure exerted on the vessels 10 by the surrounding water depth. The vessels 10 may be initially full of water at ambient pressure and temperature according to the depth of the vessels 10. As pressurized gas is pumped into the vessels 10, the water will evacuate through open ports 18 in the bottom of the vessels 10 due to the action of the compressed gas. This gas flow continues until vessels 10 may be completely filled with compressed gas at which time the gas flow may be terminated so additional compressed gas does not escape from the ports 18 located in the bottom of the vessels 10.

When it is desired to release the gas from the vessels 10, the above-mentioned outlet valve associated with the vessels 10 is opened and the hydrostatic pressure acting on the vessels 10 causes water to enter ports 18 of the vessel to force the stored gas out from the vessel and into the conduit 12. The volume of the vessels 10 and the depth of the vessel below the sea level 17 (i.e. surface of the sea) are determined in the manner discussed above so that the hydrostatic pressure acting on the vessel enables the gas to be discharged from the vessels 10 at a substantially constant discharge pressure as the volume of the gas in the storage vessel decreases. The gas discharged from the vessels 10 passes via the conduit 12, the manifold 9, and the piping 11 to the expansion side 8b of the unit 8 for generating electrical power in the manner discussed above.

This system 100 thus lends itself to the uses set forth above, including compressing and storing the gas during relatively low load conditions when the cost of electricity to compress the gas is relatively low, while permitting the stored compressed gas from the storage vessels 10 to be used in generating electricity during relatively high load conditions when the cost of the energy is relatively high. Also, due to the fact that the gas is discharged from the vessels 10 at a substantially constant discharge pressure as the volume of the gas in the vessel decreases, as described above, the efficiency is increased while the required overall storage volume is reduced. Furthermore, the system 100 may reduce susceptibility to earthquake and hurricane damage, and low sea temperatures may allow for post-compression cooling of the gas that may ensure an isothermic cycling of the gas.

It is understood that variations may be made in the foregoing without departing from the scope of the invention. For example, the shape and orientation of the storage vessels 10 may be varied from that shown in the drawings as long as the pressure differential (or pressure swing) along the height (or diameter) of the vessel is limited so that a substantially constant discharge pressure is maintained during system 100 operation, as discussed above. In one embodiment, approximately 30 feet of water may be equivalent to approximately 14.7 psi (pounds per square inch) of pressure (i.e. 1 atmosphere) of the gas within the tank. In another embodiment, a plurality of vessels 10 may be used, in which case the manifold 9 may be adapted to distribute the compressed gas to the vessels simultaneously or sequentially; otherwise the operation would be the same as described above. In another embodiment, the manifold 9 can be eliminated and the gas transferred directly to the vessels 10, especially if only one vessel is used. In another embodiment, the gas stored in the vessels 10 can be utilized in manners other than the generation of electrical power.

There are many alternate embodiments. In one embodiment, heat sinks are coupled to the vessels 10 to maintain a temperature of said compressed gases. In another embodiment, a discharging cycle for the compressed gas within a vessel may end with the vessel being substantially filled with water. In yet another embodiment, a charging cycle may include a flow of the compressed gas being selectively ended to prevent the compressed gas from escaping the ports located on the bottom of the vessel.

In one embodiment, a plurality of vessels receives compressed gas by selectively activating gas flow to each vessel of the plurality of vessels. A manifold may be used to receive and distribute the compressed gas to each of the plurality of vessels. In another embodiment, there is a sensor unit in each of the plurality of vessels and a microprocessor is coupled to receive signals for these sensor units. The sensor units and/or the microprocessor may be programmed to monitor the contents of the vessels to control a flow of the compressed gas. Monitoring may include volume, pressure and other parameters of the gas in the vessels. Monitoring may also include sensing levels of water within the vessels. In yet another embodiment, an expander may be used to selectively receive the compressed gas from each of the vessels to expand the compressed gas in a synchronous manner.

It is also understood that when the expression “gas” is used in this application, it is intended to cover all types of gas, including air, natural gas, and the like. Still further, it is understood that the piping 11 and the conduit 12 may be used to transfer the compressed gas from the compression side of the plant 8 to the manifold 9 and to the vessels 10, respectively, and another conduit and piping (not shown) may be used to transfer the stored gas from the vessel and the manifold, respectively, to the expansion side of the platform 8.

Although only a few exemplary embodiments of this invention have been described in detail above, those skilled in the art will readily appreciate that many other modifications are possible in the exemplary embodiments without materially departing from the novel teachings and advantages of this invention. Another embodiment would apply to deep water offshore wind farms and require either a free standing or floating platform that would accommodate greater depths. Accordingly, all such modifications are intended to be included within the scope of this invention as defined in the following claims. In the claims, means plus-function clauses are intended to cover the structures described herein as performing the recited function and not only structural equivalents but also equivalent structures.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

Methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals which upon reception causes movement in matter (e.g. electrons, atoms, etc.) (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

As used in this description, “substantially” or “substantially equal” or similar phrases are used to indicate that the items are very close or similar. Since two physical entities can never be exactly equal, a phrase such as ““substantially equal” is used to indicate that they are for all practical purposes equal.

It is to be understood that in any one or more embodiments of the invention where alternative approaches or techniques are discussed that any and all such combinations as may be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus a method and apparatus for compressed gas energy storage in offshore wind farms have been described.

What is claimed is:

1. A system to store energy in an offshore wind farm, said system comprising:
a source to generate compressed gas above a surface of a sea, said source coupled to a generation support tower of said offshore wind farm;
a vessel to locally store said compressed gas, said vessel having an axial axis substantially horizontal to a sea floor below said surface of the sea; and
a piping system coupled to said source and said vessel to selectively transfer said compressed gas from said source to said vessel for storage,
wherein said vessel is rigid and includes at least one port allowing a hydrostatic pressure from said sea to act on said compressed gas inside said vessel,
wherein said compressed gas may be selectively discharged from said vessel at a substantially constant discharge pressure as a volume of said compressed gas in said vessel decreases.

2. The system of claim 1 further comprising heat sinks coupled to said vessel to maintain a temperature of said compressed gas.

3. The system of claim 1 wherein a discharging cycle ends with said vessel substantially filled with sea water.

4. The system of claim 1 wherein during a charging cycle a flow of said compressed gas is selectively ended to prevent said compressed gas escaping said at least one port located on a bottom of said vessel.

5. The system of claim 1 further comprising:
a plurality of vessels including said vessel; and
a manifold coupled to receive said compressed gas from said source and coupled to distribute said compressed gas to said plurality of vessels,
wherein said coupling to distribute includes selectively activating a gas flow to each of said vessels of said plurality of vessels.

6. The system of claim 5 further comprising:
a sensor unit in each vessel of said plurality of vessels; and
a microprocessor coupled to receive signals from said sensor units,
wherein said sensor units and said microprocessor monitor contents of each vessel of said plurality of vessels to control a flow of said compressed gas.

7. The system of claim 5 further comprising an expander connected to a piping system to selectively receive said compressed gas from each of said vessels of said plurality of vessels and to expand said compressed gas.

8. The system of claim 5 further comprising a means for generating electrical power utilizing said compressed gas.

9. A method to store energy in an offshore wind farm, said method comprising:
generating compressed gas from a source located above a surface of a sea, said source coupled to a generation support tower of said offshore wind farm;
storing said compressed gas locally in a vessel, said vessel having an axis substantially horizontal on the sea floor below the surface of the sea;
selectively transferring said compressed gas from said source to said vessel for storage through a piping system coupled to said source and said vessel; and
selectively discharging said compressed gas from said vessel at a substantially constant discharge pressure as the volume of said compressed gas in said vessel decreases,
wherein said vessel is rigid and includes at least one port allowing a hydrostatic pressure from the sea to act on said compressed gas inside said vessel.

10. The method of claim 9 further comprising heat sinking said vessel to maintain a temperature of said compressed gas.

11. The method of claim 9 wherein a discharging cycle ends said selectively discharging with said vessel substantially filled with sea water.

12. The method of claim 1 wherein during a charging cycle of said selectively transferring a flow of said compressed gas is selectively ended to prevent said compressed gas escaping said at least one port located on a bottom of said vessel.

13. The method of claim 1 further comprising:
receiving said compressed gas at a manifold from said source; and
distributing said compressed gas from said manifold to a plurality of vessels which include said vessel,
wherein said manifold is coupled to receive said compressed gas from said source and coupled to distribute said compressed gas to said plurality of vessels,
wherein said coupling to distribute includes selectively activating a gas flow to each of said vessels of said plurality of vessels.

14. The method of claim 13 further comprising:
sensing using a sensor unit in each vessel of said plurality of vessels;
receiving signals at a microprocessor in response to said sensing;
processing said signals using said microprocessor; and
monitoring the contents of each vessel of said plurality of vessels to control a flow of said compressed gas.

15. The method of claim 13 further comprising:
selectively receiving said compressed gas at an expander from each of said vessels of said plurality of vessels through a piping system; and
expanding said compressed gas.

16. The method of claim 13 further comprising a means for generating electrical power utilizing said compressed gas.

17. A method comprising:
using a wind generated source of energy from a platform in a sea to create a source of compressed gas; and
sending said compressed gas to a gas storage tank wherein said gas storage tank is located proximate to said platform and proximate to a floor of said sea.

18. The method of claim 17 further comprising:
releasing from said gas storage tank said compressed gas; and
using said released compressed gas to generate electricity at a device located proximate to said platform and above a surface of said sea.

19. The method of claim 17 further comprising:
switching between said sending and said generating wherein said switching between is based on providing a maximum electrical power output from said platform.

20. The method of claim 19 further comprising:
transferring a portion of said maximum electrical power output to a land based electrical station.
